(19) United States
(12) Patent Application Publication
(10) Pub. No.: US 2015/0237045 A1
(43) Pub. Date: Aug. 20, 2015

(54) METHOD AND SYSTEM FOR ENHANCED BIOMETRIC AUTHENTICATION

(71) Applicant: Werner BLESSING, Horw (CH)

(72) Inventor: Werner BLESSING, Horw (CH)

(21) Appl. No.: 14/182,916

(22) Filed: Feb. 18, 2014

(51) Int. Cl. H04L 29/06; H04W 12/06; H04L 12/18; G06Q 50/18

(52) U.S. Cl. CPC H04L 63/0861; G06Q 50/18; H04W 12/06; H04L 12/1813

(57) ABSTRACT

A method allows for the biometric authentication of at least a first and a second user jointly representing a first legal entity or individually representing a first and the second legal entity with at least a first mobile station. The method includes the steps of enrolment and authenticating the users before performing a transaction by transferring biometric data to the authentication server that were captured from the first and the second user and by comparing the biometric data of the users received from the mobile station with biometric data retrieved from the database. The result is the provision of the corresponding authentication results required for the execution of the transaction.

The present invention relates to a method and a system for enhanced biometric authentication, particularly biometric authentication executed with a mobile telecommunication terminal.

### BACKGROUND OF THE INVENTION

Biometric authentication systems are used in different fields of application to identify and verify the identity of individuals.

In [1], A. Jain et al., BIOMETRICS, Personal Identification in Networked Society, Kluwer Academic Publication, Massachusetts 2002, chapter 4, page 4, the following seven factors for the qualification of a biometric in view of usability for authentication purposes are identified. “UNIVERSALITY”, requiring that every person using a system has the characteristic or the trait; “UNIQUENESS”, requiring that only one person has the same embodiment of the characteristic; “PERMANENCE”, requiring that the characteristic is invariant with time; “COLLECTABILITY”, requiring that the characteristic can be measured quantitatively; “PERFORMANCE”, referring to achievable identification accuracy, speed, and robustness; “ACCEPTABILITY”, referring to the extent people are willing to accept the biometric system and “CIRCUMVENTION”, referring to the robustness against fraudulent attacks.

While, modern biometric authentication systems meet these seven factors fairly well, research remains in progress for creating even more secure authentication systems.

[2], U.S. Pat. No. 8,370,262B2, which is enclosed herein in its entirety, discloses a method for a multi-modal biometric authentication system that allows reaching low equal error rates EER that ensure strong authentication of an individual. This network-based biometric system, which uses challenge response procedures, allows reliable biometric authentication of an individual by means of an authentication server, which is accessible over a network from end user terminals that are equipped with audio- and video-recording devices and that are designed for simultaneously capturing biometric audio and video samples from the end users. During enrolment of an end user, biometric audio and video samples are simultaneously captured and stored in a database. For on-line authentication of the end user, biometric audio and video samples are simultaneously captured for speech elements expressed by the end user in response to a challenge relating to randomly assembled speech elements. By comparing the online captured biometric audio and video data with correspondingly assembled biometric data retrieved from the database the end user can reliably be authenticated.

Depending on the transactions planned by the end user the factor “ACCEPTABILITY” is suboptimal in said system. For routine transactions, such as entering a building or a car, the described challenge/response procedure with its high trust level is overkill. In this range of transactions, “ACCEPTABILITY” has been improved with the method disclosed in [3], US2013225129A1, that can conveniently be applied by capturing biometric data during movements of the user when routinely handling his mobile station. Hence biometric authentication is executed without being noticed by the user, wherefore the factor “ACCEPTABILITY” is significantly increased.

However, the major challenges experienced in this field of technology lie still in the range of transactions that require highest security.

In this range the factors “CIRCUMVENTION” and “PERFORMANCE” are still in the focus of further developments.

[4], P. A. Johnson, B. Tan, S. Schuckers, Multimodal Fusion Vulnerability to Non-Zero Effort (Spoof) Imposters, ECE Department, Clarkson University Potsdam, N.Y. 13699, USA, Dec. 12, 2010, is focused on the security risk in multimodal biometric systems due to spoof attacks by imposters. It is stated that the key to creating a secure multimodal biometric system is in how the information from the different modalities is fused to make a final decision.

While fusing different values obtained from a multimodal biometric system in order to obtain a final decision is an important factor, it appears that the factors “CIRCUMVENTION” and “PERFORMANCE” more strongly depend on the quality of information gained at the input stage of the biometric authentication system.

However, gaining further biometric information typically involves considerable technical efforts. Hence, expanding multimodal biometric systems by adding further modalities leads to considerable costs. Consequently a further factor, namely “EFFICIENCY” becomes an issue. Adding a further modality increases security by a proportional share, but creates a rather small additional obstacle for an imposter. E.g., adding fingerprint recognition to a multimodal system, leads to a small quantitative but not to a qualitative problem for an imposter.

Further, in [4] it is pointed to the fact that typically a trade-off between performance and security exists in multimodal systems. E.g., using a more secure algorithm, in order to address the issue of a spoof attack on a partial subset of the biometric modalities, would require adequate performance in all modalities.

Further, vulnerabilities in biometric authentication systems are described in [5], Anil K. Jain, Arun Ross, and Umut Uludag; BIOMETRIC TEMPLATE SECURITY: CHALLENGES AND SOLUTIONS, http://biometrics.cse.msu.edu. This article is specifically focused on attacks designed to elicit information about the original biometric data of an individual from stored templates by an attacker.

A template represents a set of salient features that summarizes the biometric data (signal) of an individual. Due to its compact nature, it is commonly assumed that the template cannot be used to elicit complete information about the original biometric signal. However, recently it has been demonstrated that a face image can be regenerated from a face template using “Hill Climbing” methods. “Hill Climbing Attacks” are possible, when the attacker has the ability to inject raw biometric sample data of features directly through a trojan horse attack or a man-in-the-middle attack. In the event that an attacker gets access to templates, then the attacker may alter the templates or may derive data that then are used for attacking purposes. In order to avoid attacks related to templates, document [5] recommends the application of watermarking techniques that allow detection of regions that have been tampered by an attacker. However, it would be desirable to obtain even stronger protection for templates or templates that are not prone to “Hill Climbing Attacks”.

A further significant problem is the loss of templates, which can be misused, e.g. for replay attacks. As stated above a face image can be regenerated from a face template, wherefore the transmission of templates across the Internet involves considerable risks.

Still further, in the event that two parties are involved in a transaction, then each party will be authenticated individually at a trusted authority. Consequently, two biometric authentication systems are required, which are often completely independent. Hence, in view of the redundancy of the applied systems the factor “EFFICIENCY” appears to have potential for improvement. Besides it must be noted that handling to different biometric systems is cumbersome for the users.

It is therefore an object of the present invention to provide an improved method for performing secure biometric authentication, particularly biometric authentication with the use of at least one mobile station.

More particularly, it is an object of the present invention to provide an authentication method that allows execution of high-value transactions both with increased security and increased performance, while maintaining acceptability.

Furthermore the inventive method shall reliably exclude repudiation conflicts of any origin.

More particularly, the inventive method shall allow execution of transactions under the adherence to business policies and regulations defined, e.g. by private enterprises or public institutions.

Still further, attacks such as man-in-the-middle attacks that relate to exploiting or compromising template information shall be countered.

Further, the inventive method shall allow avoiding the loss of templates and biometric data of the users of the biometric authentication system.

Furthermore, a biometric authentication system and a mobile station shall be defined that advantageously allow implementation of the inventive method.

### SUMMARY OF THE INVENTION

The above and other objects of the present invention are achieved by a method, a biometric authentication system and a mobile station as defined in claim 1, claim 13 and claim 14.

The method allows biometric authentication of at least a first and a second user jointly representing a first legal entity or individually representing a first and a second legal entity with at least a first mobile station that comprises a display, at least one camera, at least one microphone and an interface that is connectable to an authentication server via a communications network. The inventive method comprises the steps of
a) enrolment at least of the first and the second user by capturing and storing biometric data together with further data required for the identification of the first and the second user in a database;
b) authenticating at least the first and the second user before performing a transaction by:
(c) setting up a communication channel at least between the first mobile station, preferably the legal entities, and the authentication server;
d) transferring biometric data from the first mobile station to the authentication server that were captured from the first and the second user with the at least one camera and the at least one microphone; and
e) the authentication server comparing the biometric data of the first and the second user received from the mobile station with biometric data retrieved from the database and providing authentication results required for the execution of the transaction.

Based on the transferred biometric data the users can be authenticated and the related data can be retrieved from the presented entities in order to confirm that the users represent said entities. Conveniently, providing further information can be limited.

However, in a basic embodiment the following steps are executed in addition
personal data of the first and the second user and/or identification data of the first legal entity or the first and the second legal entities are entered into the first mobile station and forwarded to the authentication server; so that
the authentication server can retrieve information for the first and the second user and the first legal entity or the first and the second legal entities from a database and can verifying, whether the first and the second user truly represent the first legal entity or the first and the second legal entities respectively.

The inventive solution provides improvements for various of the factors described above. Particularly the factors “PERFORMANCE”, referring to achievable identification accuracy, speed, and robustness; “ACCEPTABILITY”, referring to the extent people are willing to accept the biometric system and “CIRCUMVENTION”, referring to the robustness against fraudulent attacks are significantly improved. Furthermore, the factor “EFFICIENCY”, which has not been discussed so far, is strongly improved.

The core of the invention lies in the fact that two joint or independent users use a single mobile station for performing the authentication required for the transaction. By this measure only one biometric authentication system and only one terminal is required for executing authentication processes and performing the transaction, thus strongly increasing efficiency.

Most efficient is the use of a mobile station with two cameras on opposite sides. A representative of a first legal entity, e.g. a salesperson of a warehouse or a restaurant, can use the mobile station for taking biometric samples from the client on one side and herself on the other side. Biometric samples of both parties are forwarded to the authentication server, which can authenticate both users and can record the whole transaction to any desired detail. Hence, a salesperson can sequentially pick up any number of orders, which can be handled with the highest security level and highest efficiency. However, not only key factor “EFFICIENCY”, but also the factor “ACCEPTABILITY” is strongly improved by this method, since the execution of the authentication procedures, which can be performed within seconds, is neither burden to the customer, nor to the salesperson.

The inventive mobile station can also be used for authenticating two users, which jointly represent a single entity. Authenticating joint users according to the inventive method improves all factors mentioned above. Besides the factors “EFFICIENCY” and “ACCEPTABILITY”, the factors “PERFORMANCE” and “CIRCUMVENTION” can be significantly improved.

The invention provides a solution to the problems initially described and creates a major obstacle for imposters that intend to harm users of an authentication system by exploiting known system weaknesses.

The inventive method is not primarily focused on the final stage of the biometric authentication process but on the initial stage where new and valuable biometric information is processed with increased efficiency.

The inventive method makes use i.a. of the fact that legal transactions typically involve parties with at least two persons each. Two users can jointly represent a single entity or individually represent two different legal entities.

With the inventive method two or more users that represent one or more legal entities can use a single mobile station to perform a transaction, which requires authentication.

According to company policies of a legal entity, often two executives are required to jointly sign a contract or to complete a high-value transaction in the name of the legal entity.

In private life a large part of transactions with a relatively high value are executed by partners, e.g. by married couples that use a common bank account. However, typically, only one person of the couple is performing the transaction and is thus authenticated. Valuable information is therefore neglected which would be available at the place of transaction. According to the invention, this information, which has been neglected so far, is advantageously used with little effort but great effect. Since both partners are often present when high-value transactions are executed, e.g. during vacation, at home when online shopping or when shopping in town, additional information from the partner can be gained practically without further effort.

Hence, according to the present invention the biometric resources neglected so far are advantageously used without burden to the involved users, thus significantly improving performance and security of biometric systems.

Furthermore, overall security of the companies and partners with a common bank account is systematically enlarged. Company executives are systematically required to execute transactions according to the company policy. Partners with a common account are systematically required to provide mutual consent to a transaction. Mutual consent in both cases is simply given by performing individual authentication, which requires only a few seconds but provides a strongly increased trust level. Consequently the authentication threshold can even be lowered in order to reduce the false rejection rate while the false acceptance rate will still be lowered compared to conventional procedures. While achieving higher security, performance is also improved.

In preferred embodiments multimodal biometric authentication is performed preferably for both partners, e.g. two executives of a contracting party as described for example in US8370262B2.

Multimodal biometric authentication is preferably performed with a method comprising the steps of
a) performing enrolment of each user by
a1) capturing biometric audio and video samples from each user during enrolment procedure for speech elements or speech segments expressed by the end user in response to dictated speech elements or speech segments;
a2) storing the profile of the enrolled user in a database together with the dictated information and the accordingly captured biometric audio and video samples;
b) performing on-line authentication of each end user by
b1) sending at least one challenge with information representing a sequence of randomly assembled dictated speech elements or speech segments, for which biometric audio and video samples were captured, to the mobile station and requesting a corresponding response;
b2) sequentially capturing biometric audio and video data simultaneously from each user via the at least one camera and the at least one microphone of the mobile station for the response expressed by the users;
b3) the mobile station forwarding the biometric data captured from the joint users to the authentication server;
b4) the authentication server;
   receiving the biometric data of the joint users from the mobile station,
   retrieving biometric data of the joint users from a database,
   assembling the biometric data of the joint users retrieved from the database to represent the challenge,
   comparing the biometric data of the joint users retrieved from the database and assembled to represent the challenge with the biometric data of the response and
   returning the result of the authentication procedures to the mobile station and/or to the third party.

Authenticating a second user with this method requires little effort, since the whole authentication process has been initiated by the first user. The second user is simply required to provide biometric data without interacting with the mobile station.

For an imposter however handling an additional user represents a more significant problem than adding a modality for a single user. Adding a further user rather adds a further dimension to the problems of an imposed. The imposter now has to impersonate not only one but two individuals. Complexity of spoofing and the probability that a spoofing attack will fail is strongly increased. Furthermore, the biometric authentication system can verify different characteristics of each user selectively by applying different modalities, thus further increasing the obstacles for an imposter. E.g., for one user fingerprint recognition and face recognition is performed, by for the other user only voice recognition and face recognition.

The authentication server may provide a specific challenge for each user. Alternatively both users may respond to a single challenge. Still further, the challenge may be split in two parts with a first challenge part, which induces a second challenge part to be responded to. The first part of the challenge may be for example the question “WHAT IS YOUR NAME”. The first user would repeat this challenge, while the second user would reply with his name “MY NAME IS . . . ”. The challenge provided by the authentication server may also be a first part of a verse, which is repeated by the first user, while the second user response with the second part of the verse.

In a preferred embodiment the mobile station combines or fuses the responses captured from the joint users preferably for each modality and sends the combined response to the authentication server. With this measure man-in-the-middle attacks are efficiently countered.

E.g., the superposition of optical or acoustical data provides superimposed biometric characteristics which are valuable for authentication purposes. However, since the superposition of data does not correspond to a natural person but to a synthetic person the attacker is confronted with severe difficulties when trying to impersonate a synthetic person or to generate the related mixture of traits.

The authentication server however compares the combined response with a combination of retrieved and assembled biometric data representing the challenge or a corresponding superposition of templates.

Furthermore, by avoiding the transfer of templates, from which biometric data of a user can be regenerated, user data are protected and the loss of templates, which appears to be a key weakness of the distributed biometric authentication systems, can be avoided as well.

The inventive method opens therefore a new dimension in authentication technology, in which an imposter has not yet the required countermeasures. The inventive method is highly efficient and can easily be applied, while the countermeasures of an imposter will take considerable efforts.

During enrolment and during authentication procedures templates are established for the biometric data captured from the users. Further, superposition is of the templates can be made, which are transferred from the mobile station to the authentication server.

After the templates have been matched, the resulting match values are individually or jointly compared with a security threshold. As described above, values obtained from different modalities can be fused with a desirable weight in order to obtain a suitable overall match value.

In a preferred embodiment the authentication server retrieves information from the legal entities indicating whether the users are entitled to execute a transaction either jointly or individually. Authentication procedures then fail, if the authorisation is missing.

The legal entity may also be an organisation that is managing the bank account of the joint users. The information retrieved from the legal entity or organisation indicates whether the joint users are empowered to debit charges to this bank account. Preferably the information defines maximum transaction value or charge that can be debited to the bank account by individual or joint signature.

The authentication server preferably handles requests for authentication both for joint users and single users and determines for this purpose based on the data retrieved from the legal entity authorisation in further detail. E.g., a single user may be empowered to execute a transaction with an amount below a predefined value. Company regulations may entitle an executive to execute transactions with single signature below a specified value but may require joint signature for transactions above said value. Similarly, partners holding a common account may debit the account with small values individually but will be required to execute larger transactions jointly. Furthermore, the authentication server or the legal entity may limit the sum of amounts sequentially debited by single signature to a specific value which must not be exceeded.

Data are preferably downloaded online from the legal entities. Policies and regulations to be applied may also be pre-stored in a local database accessed by the authentication server.

The inventive method therefore closes several gaps in the security network of companies, enterprises, public institutions and private partners. While performing authentication the inventive method also ensures adherence to policies and regulations, which are often inadvertently neglected.

In this respect the inventive method goes one step beyond conventional authentication procedures, which try to avoid repudiation conflicts. While a user could correctly be authenticated before signing a contract, the contract could still be repudiated in view of a violation of company policies published in official registers, which indicate authentication to sign of the executives of a legal entity. However, in these official publications detailed authentication to sign cannot be listed.

E.g., an executive may be assigned authorisation to sign single for matters of his own department, while for other matters, which may concern more than one department, joint signature may be required. Furthermore, the executive may purchase goods up to a specific limit with single signature. In the declaration to the authentication server or the authentication authority operating the authentication server the legal entities can provide authorisation profiles for their employees that can be applied during authentication procedures. In a framework contract closed with contractual partners the legal entities can declare that these authorisation profiles are legally binding.

In preferred embodiments conference calls are set up between the authentication server and at least two mobile stations. In order to obtain a strong binding between the parties for a given transaction authentication procedures are performed at least once during each conference session that are absolutely their wine should multiple minor need the money so I lay on the David H scare has ever the guide was omitted the mild exactly why you have a further session saw Malaga the Taliban was living democracy goal of the keepers model reaches the position you that was it that of.

After terminating the authentication procedures, the authentication server preferably issues a certificate reflecting the result of the performed authentication session and indicating at least the users involved, their status of authentication and their authorisation to sign. Based on this certificate, repudiation of a declaration to close a contract can be rejected.

In a further preferred embodiments, mobile stations are used that comprise a camera and a display on the front side and a camera on the rear side. Hence, joint users can sit on opposite sides of the mobile station and can conveniently perform authentication procedures. The first user sets up the mobile station for the authentication procedures and provides a response to a challenge when requested. Seamlessly the second user can repeat the challenge heard from the first user without the requirement of interacting with the mobile station. In a further preferred embodiment the mobile station, e.g. a tablet computer, can comprise on both sides a display so that the second user can respond to a challenge when prompted. Alternatively or in addition an acoustical guide may be provided, which leads both users through the authentication procedures.

After authenticating the users any transaction may be performed with the mobile station that displays for example a specific page of a service provider.

In the event that a further user or further joint users are involved as a second party in the transaction, then this user or these joint users are authenticated subsequently.

### BRIEF DESCRIPTION OF THE DRAWINGS

Some of the objects and advantages of the present invention have been stated, others will appear when the following description is considered together with the accompanying drawings, in which:

FIG. 1 shows a biometric authentication system with an authentication server 2 and two mobile stations 1XY, 1Z interconnected across a network such as the Internet 10 and three users X, Y and Z performing a transaction;

FIG. 2 shows mobile station 1XY of FIG. 1, which comprises a complete biometric authentication system;

FIG. 3 shows mobile station 1XY of FIG. 1 while a further biometric authentication is executed according to the inventive method;

FIG. 4 shows the biometric authentication system of FIG. 1 with the first user X representing one enterprise E2 and the second user Y representing another enterprise E1, and

FIG. 5 shows the biometric authentication system of FIG. 1 with the first user X and the second user Y representing the same enterprise E1.

### DETAILED DESCRIPTION OF THE PREFERRED EMBODIMENTS

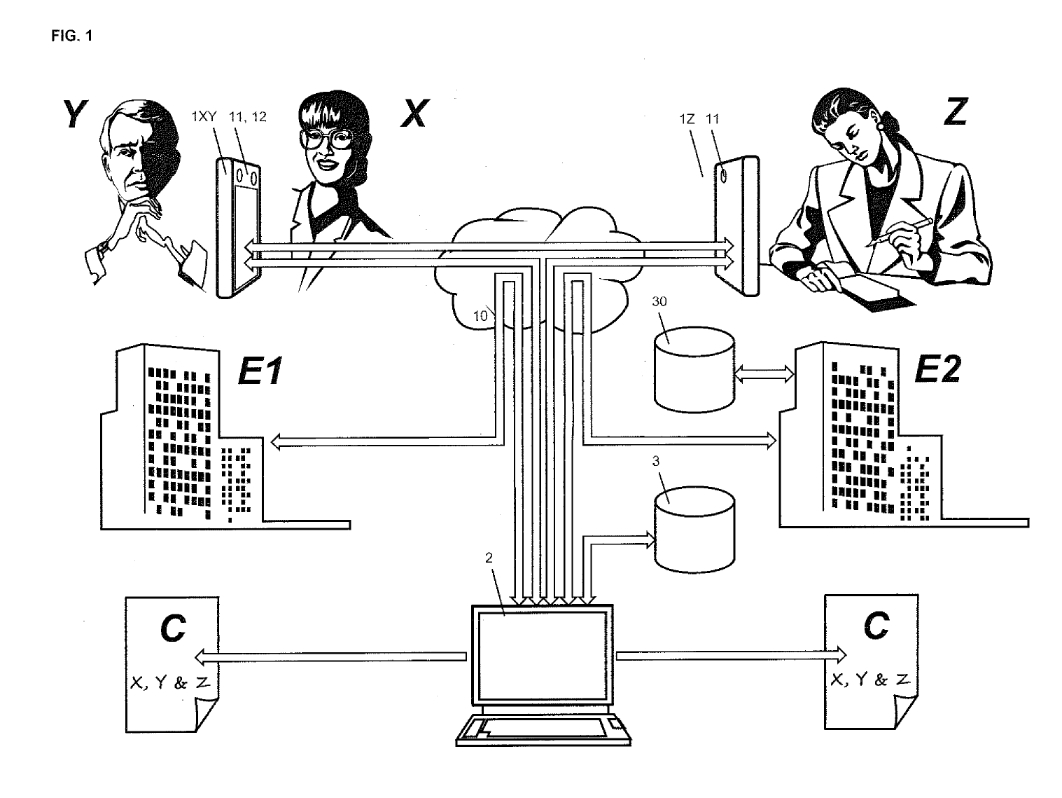

FIG. 1 shows a biometric authentication system comprising an authentication server 2 and two mobile stations 1XY, 1Z interconnected across a network such as the Internet 10. The authentication server 2 is further connected or connectable to server systems of a first enterprise E1 and a second enterprise E2. As an example it is shown that the server in the second enterprise E2 comprises a database 30 from which data can be downloaded to a local database 3 that is connected to the authentication server 2.

The first mobile station 1XY is used by users X and Y individually representing a first legal entity E1 and a second legal entity E2 or jointly representing the first entity E1 only. The mobile station 1XY is operated for example exclusively by user X. In both options, the users X and Y can be authenticated with the biometric authentication system of FIG. 1. Hence, only one biometric authentication system is required for all authentication procedures described below.

According to the first option, the users X and Y individually represent a first legal entity E1 and a second legal entity E2, respectively. User X may be a salesperson and user Y may be a customer. The mobile station 1XY, which acts as a terminal of the biometric authentication system and which in a preferred embodiment can incorporate a complete biometric authentication system itself, is positioned between the users X and Y. Hence, in a preferred embodiment user X can be recorded with a camera 11 located on the front side of the mobile station 1XY and user Y can be recorded with a camera 11 located on the rear side of the mobile station 1XY. Consequently, in response to at least one challenge, biometric data can be captured easily from both the first and the second user X, Y. User X, e.g. the owner of the mobile station 1XY, can move from customer Y to further customers in order to collect orders. For each order biometric data can be captured and authentication procedures can be performed. This embodiment of the invention can be implemented at any point of sale, e.g. in restaurants, shopping centres, cinemas, etc. In preferred embodiments the conversation of the users X, Y used for ordering in article or buying a ticket is also used for authentication purposes. E.g., a user enters the sales point at a cinema and orders a ticket and is automatically authenticated. The ticket is issued as soon as authentication procedures have successfully been completed. At the same time the salesperson has been authenticated. The sales contract closed is therefore completely documented.

According to the second option, the joint users X, Y represent the first enterprise E1, which is a first legal entity. Joint users X, Y are entitled to execute transactions below a specified transaction value by single signature and above the specified transaction value by joint signature only. However, authorisation to sign can be assigned more selectively. E.g., by a decision of the board of directors, representative Y can be empowered to execute transactions in a specific range by single signature without limitation. Such empowerment is typically not published in a public register. In principle, a contracting party would require a legalised statement of the decision of the board of directors as prove for the validity of the executed contract. However, such requirements are often neglected.

The second mobile station 1Z is used by user Z, who represents the second enterprise E2 that is a second legal entity. User Z, e.g. the company director, is authorised to sign contracts by a single signature without limitation.

In the given example, the first enterprise E1 and the second enterprise E2 have been negotiating a contract, which is now due for signing by representatives X, Y on one side and representative Z on the other side. The contract value or transaction value is high so that maximum security is required. Particularly, repudiation conflicts shall be avoided such as repudiations claiming incorrect authentication or violation of company policies. Formalities, such as legalising declarations shall however be avoided.

In order to close the contract the users or representatives X, Y and Z proceed according to the inventive method as follows.

Before authentication procedures are performed, the users get enrolled at the authentication server or a related registration authority, as described e.g. in [2], US8370262B2.

For the enrolment, a user provides credentials, i.e. a passport, to a registration officer who verifies the user's data and establishes a non-biometric user profile.

Then, in order to establish a biometric user profile the registration officer takes biometric samples from the user, e.g. by dictating speech elements or speech segments, which are repeated by the user. For the corresponding speech elements expressed by the user, biometric audio and video samples are captured preferably simultaneously by means of recording devices that are connected to a registration server. In order to ensure that during authentication procedures any desirable challenge can be chosen, preferably all speech elements, together with the related gestures of lips and tongue, are taken and stored. Typically the user will be asked to repeat all letters of the alphabet as well as all relevant numbers, e.g., 1-100, and 1000.

Consequently based on the recorded speech elements any challenge including new word creations can be generated. In smaller systems, it is also possible to record a specific number of words and preferably the related lip movements. This would lead to simpler procedures but to a reduced number of potential challenges.

The captured biometric elements that represent the user's biometric profile are then stored together with the non-biometric profile in the database 3 or directory of the authentication server or registration authority. The registration server preferably comprises a feature extraction module, which processes the scanned biometric data to extract a feature set that is useful in distinguishing between different users and that is preferably entered into a template, which is stored in a template database 3.

Further stored is information, which identifies the captured biometric elements. This information may be stored in the form of dictated speech elements or speech segments or preferably as a code that points to the dictated speech elements or speech segments e.g. text-, audio- or graphics-files that stored in the database 3. The information, which relates to the dictated speech elements or speech segments may be stored as text, which may be used as the file name for the captured audio and video sample files.

After enrolment procedures have been completed, authentication procedures involving one, two or more registered users and one or more contractual parties can be performed.

For this purpose an authentication session is initiated and communication channels are established, e.g. as illustrated in FIG. 1. Between the mobile stations 1XY, 1Z and the authentication server 2 preferably two or more physical or logical channels are established, preferably two audio channels and two video channels.

With the initialisation of the authentication session the joint users X, Y and the single user Z provide personal information and indicate the legal entities E1, E2 they represent. It must be noted that the term “legal entity” needs to be interpreted broadly, since the users X, Y may represent the first enterprise E1 as executives or may represent as a married couple themselves as the owners of a bank account that is under the control of the first enterprise E1. Based on the information received, the authentication server 2 retrieves information for the users and the legal entities and verifies whether the users actually represent the legal entities E1, E2 as declared.

The inventive method has the advantage of enormous flexibility so that the application of the method can precisely be adapted to the requirements of the users and the legal entities. In a preferred embodiment the authentication server 2 retrieves data from the legal entity E1 related to the joint users defining authorisation of the joint users X, Y to sign contracts or to execute a transaction, such as a bank transaction.

If the joint users X, Y are a married couple, which possesses a bank account at the first enterprise E1, the joint users X, Y may define in an agreement, above which transaction value joined signature will be required. This agreement is stored at enterprise E1 and can be locked up by the authentication server. E.g., if the critical transaction value lies at USD500 and user X is purchasing a new watch having a value of USD200, then this transaction can be executed with single signature of user X. However for buying a watch with a value of USD750 joined signature of both users X and Y would be required. In this way any policy established by an enterprise for its executives or by private people for their personal affairs can be set up and reliably be enforced. Benefit of this method is avoiding wilful violation of agreements and violation of policies due to lack of knowledge and negligence when handling transactions. Business policies will therefore be automatically be adhered to without specific efforts.

For authentication purposes, challenges are then sent to the mobile stations 1XY, 1Z and corresponding responses are recorded from the users X, Y and Z. Challenges are selected according to the available speech elements. In preferred embodiments a random challenge/response procedure is applied with randomly select the challenges for which corresponding speech segments are taken from the database 3 and are assembled accordingly.

A feature extraction module processes the biometric data scanned during the authentication session to extract a feature set that is preferably entered into a template, which is sent within the distributed biometric authentication system of FIG. 1 over the Internet 10 to the authentication server 2 as further described below. A matcher module provided in the authentication server 2 accepts the feature set received e.g. from the mobile station 1XY and a corresponding feature set retrieved from the database 3 as inputs, and outputs a match score indicating the similarity between the two sets.

Then, as described above the obtained match values are compared, before or after fusing, with a threshold in order to obtain a result for the authentication procedures, which then is forwarded to the network entities 1XY, 1X of the users X, Y and Z and preferably the legal entities E1, E2.

Already at this stage, the authentication server 2 may issue a certificate C that indicates the result of the authentication procedures and preferably the transaction involved.

Based on the result of the authentication procedures, the transaction is executed or the negotiated contract is signed. For the executed transaction or the signed contract the authentication server may again issue a certificate C indicating all the details and parties of the transaction.

Consequently, the inventive method not only provides a significantly increased trust level and improved performance but also significantly enlarged overall security for all involved parties. The first legal entity or enterprise E1 represented by the joint users X, Y can rely on the adherence of their executives to defined rules and policies. The second legal entity or enterprise E2 represented by user Z can rely on the contract which cannot be repudiated by the first legal entity E1, and vice versa.

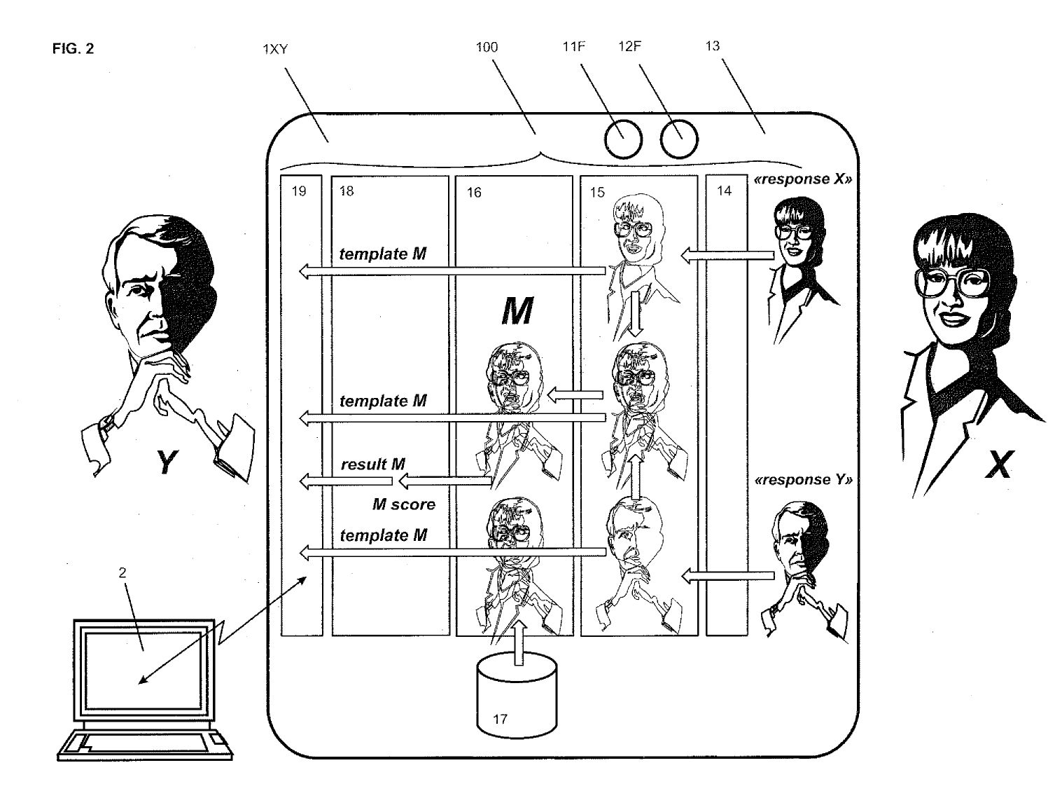

FIG. 2 shows mobile station 1XY of FIG. 1, which comprises a complete biometric authentication system with six major modules namely sensors 11R, 12R, a feature extractor 14, a template generator 15, a template database 17, a matcher module 16, and a decision module 18. Further provided is an interface module via which the mobile station 1XY can exchange data with the authentication server 2.

The sensors 11R, 12R, which are the interface between the user and the authentication system, allow scanning the biometric trait of the user. The feature extraction module 14 processes the scanned biometric data to extract a feature set that is useful in distinguishing between different users and that is preferably entered into a template by the template generator 15. The template generator 15 forwards the generated template to a first input of the matcher module 16. A corresponding template generated during enrolment is forwarded from the template database 17 to a second input of the matcher module 16, which determines a match score indicating the similarity between the two feature sets processed. The obtained match score is compared with a threshold in the decision module 18, which forwards a first identity decision over the Internet 10 to the authentication server 2.

For operating the modules 14, 15, 16, 17, 18 of the biometric authentication system, which preferably are all integrated in the mobile station 1XY, a programme module 100 is provided.

For implementing the inventive method the integration of the extraction module 14 into the mobile station 1XY would however already be sufficient. However, also the transfer of raw biometric data that can be processed in the authentication server 2 would be sufficient.

The biometric authentication system fully integrated into the mobile station XY allows preliminary authentication of the users X, Y. In the event that the internal authentication is successful, then the authentication server 2 will proceed with the authentication session.

In FIG. 2 illustrates a particularly preferred embodiment of the biometric authentication system that combines and fuses captured feature sets of different users preferably for one modality.

It is illustrated that images of the faces of the users X and Y were captured by the cameras 11F, 11R of the mobile station 1XY and are displayed on the screen 13. These pictures symbolically represent the responses of the users X and Y for a given challenge. The extraction module 14 extract feature sets from the biometric data. The template generator 15 creates three templates, a first template with the feature set of user X, a second template with the feature set of user Y and a template with fused feature sets of users X and Y. The process of fusing the feature sets of users X and Y into a single template can be done in various ways. Preferably the individual templates are simply superimposed. Alternatively raw data or feature sets are superimposed before the final template is made. The superposition of audio, video or other data has again specific characteristics, which can be extracted in order to obtain a synthetical feature set.

By transferring templates with fused data or fused characteristics from the mobile station 1XY to the authentication server 2 (see FIG. 2, template M), man-in-the middle attacks are strongly countered. The attacker expects that the transferred template relates to a single user but will not have related information available and therefore will be unable to impersonate the synthetical user. Instead of watermarking templates by adding information, which does not relate to biometric data, the present invention proposes to alter the data content completely by mixing biometric data in in a selected processing stage. Watermarking techniques can be applied in addition.

Furthermore, data on its way from the mobile station 1XY to the authentication server 2, which is intercepted by an attacker, is of little value. Consequently, private biometric data of the users of the inventive biometric authentication system is protected.

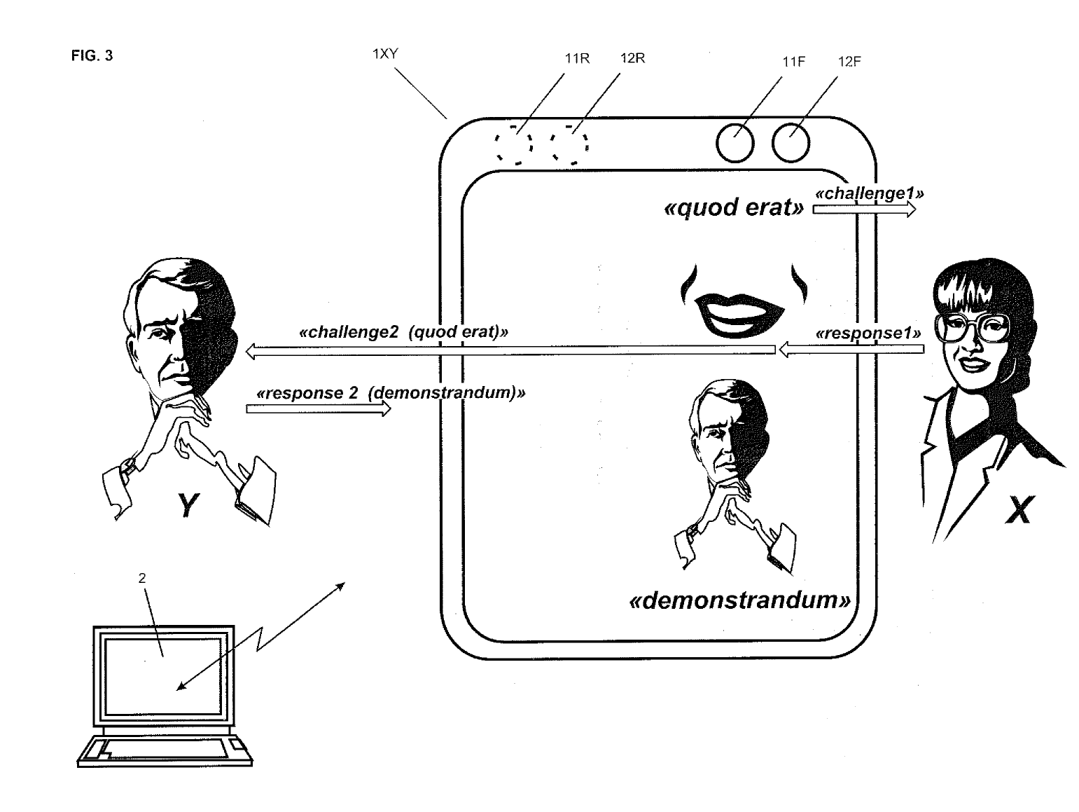

FIG. 3 shows mobile station 1XY of FIG. 1 while a biometric authentication is executed according to the inventive method under the control of the authentication server 2 or the mobile station 1XY itself, which comprises a camera 11F on the front side and a camera 11R on the rear side.

It is shown that the challenge <<quod erat>> has been issued, which is read and repeated by user X. The response of user X, which is heard by user Y, is the beginning of a sentence, which forms a second challenge. User Y is requested to complete the sentence and replies <<demonstrandum>>. Again by this procedure the man-in-the-middle is confronted with an additional problem. A challenge cannot automatically be intercepted and replied to. Such a challenge consists therefore of at least two parts with a first challenge part that induces a second challenge part at the user's site. Such challenge constructs can easily be found or can be agreed upon during registration. Challenges can easily be built e.g. with numerical series, such as <<1-2-4>> repeated by user X and completed by user Y with <<8-16-32>>.

The inventive method therefore opens new and effective resources for countering various attacks and reaches at the same time a high performance with low failure rates. Further the invention provides overall security for its users and related legal entities. Further, the inventive method acts pre-emptive by avoiding the transfer of information that could be exploited by new methods in order to obtain material for compromising the biometric authentication system.

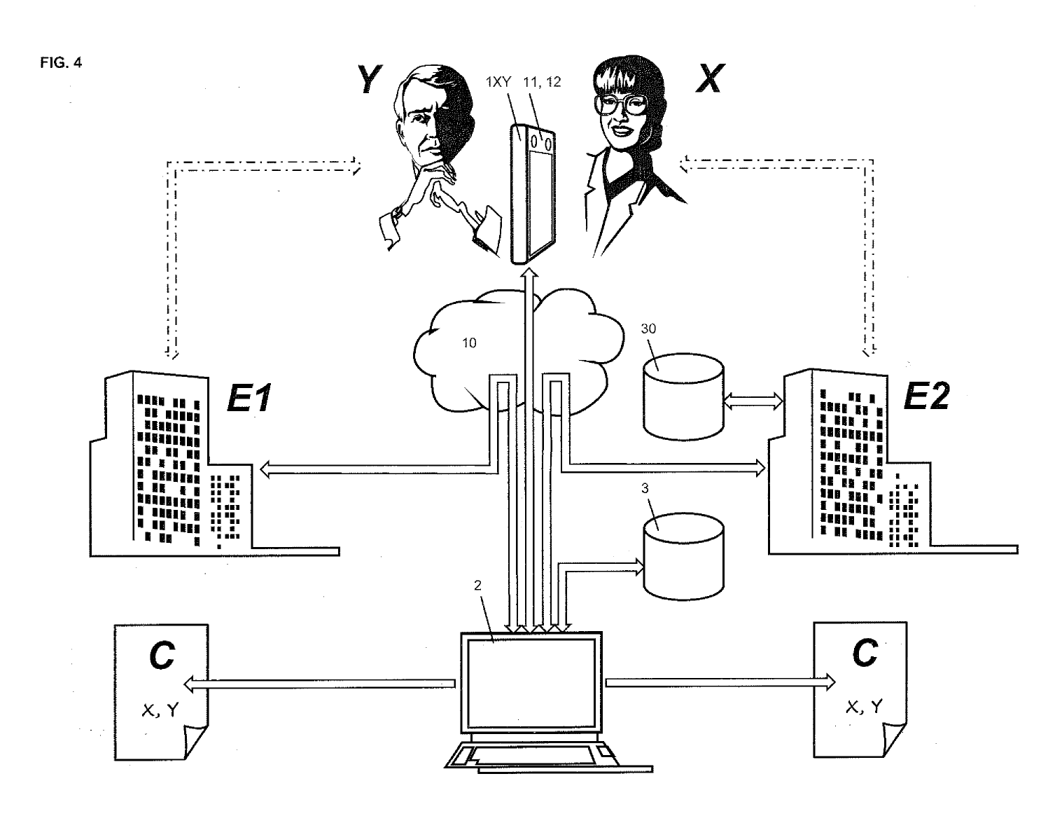

FIG. 4 illustrates the biometric authentication system of FIG. 1 with the first user X representing one enterprise E2 and the second user Y representing another enterprise E1. As described above. Both users X and Y can individually be authenticated with the same biometric authentication system and with a single mobile station 1XY that is used as communication terminal for the biometric authentication system.

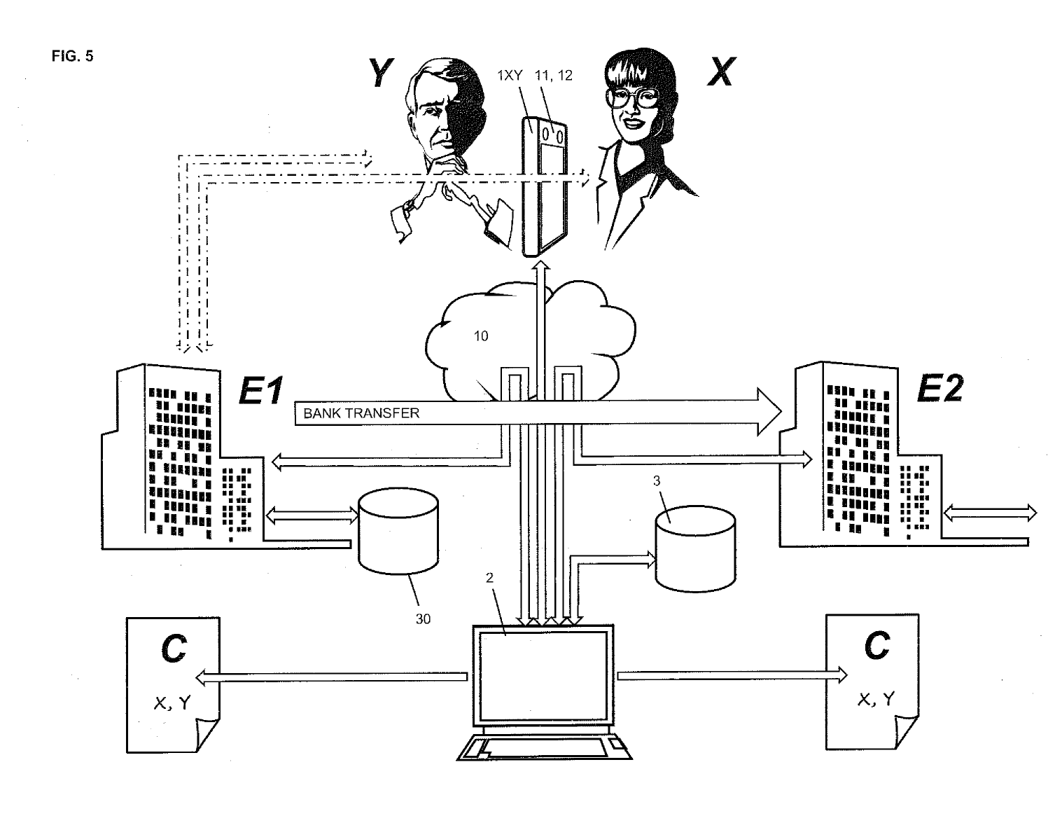

FIG. 5 illustrates the biometric authentication system of FIG. 1 with the first user X and the second user Y representing the same enterprise E1. As described above the users X and Y may be executive of the enterprise E1 or may be a married couple having a bank account at the enterprise E1. E.g., the married couple has bought a car at enterprise E2 and is now arranging for a bank transfer from their bank account at enterprise E1 to the bank account of enterprise E2.

### LITERATURE

[1] A. Jain et al., BIOMETRICS, Personal Identification in Networked Society, Kluwer Academic Publication, Massachusetts 2002
[2] U.S. Pat. No. 8,370,262E2
[3] US2013225129A1
[4] P. A. Johnson, B. Tan, S. Schuckers, in Multimodal Fusion Vulnerability to Non-Zero Effort (Spoof) Imposters, ECE Department, Clarkson University Potsdam, N.Y. 13699, USA, Dec. 12, 2010
[5] Anil K. Jain, Arun Ross, and Umut Uludag; BIOMETRIC TEMPLATE SECURITY: CHALLENGES AND SOLUTIONS, http://biometrics.cse.msu.edu.

1. A method for biometric authentication of at least a first and a second user jointly representing a first legal entity or individually representing a first and a second legal entity with at least a first mobile station that comprises a display, at least one camera, at least one microphone and an interface that is connectable to an authentication server via a communications network, comprising the steps of
a) enrolment at least of the first and the second user by capturing and storing biometric data together with further data required for the identification of the first and the second user in a database;
b) authenticating at least the first and the second user before performing a transaction by:
c) setting up a communication channel at least between the first mobile station and the authentication server;
d) transferring biometric data from the first mobile station to the authentication server that were captured from the first and the second user with the at least one camera and the at least one microphone; and
e) the authentication server comparing the biometric data of the first and the second user received from the mobile station with biometric data retrieved from the database and providing authentication results required for the execution of the transaction.

2. The method according to claim 1, wherein the steps of authenticating the first and the second user before performing a transaction comprise
transferring personal data of the first and the second user and identification data of the first legal entity or the first and the second legal entities from the first mobile station to the authentication server;
the authentication server retrieving information for the first and the second user and the first legal entity or the first and the second legal entities from a database and verifying, whether the first and the second user truly represent the first legal entity or the first and the second legal entities respectively.

3. The method according to claim 1 for performing biometric authentication of the joint first and user that are representing the first legal entity and a third enrolled user that is representing the second legal entity and that is using a second mobile station that comprises biometric sensors and an interface that is connectable to the authentication server via a communications network, comprising the steps of
a) the first mobile station providing personal data of the joint users and identification data of the first legal entity;
b) the second mobile station providing personal data of the third user and identification data of the second legal entity;
c) the authentication server retrieving information for the joint users and the first legal entity as well as information for the third user and identification data of the second legal entity and verifying, whether the joint user and the third user truly represent the first legal entity and the second legal entity respectively;
d) the first mobile station providing biometric data to the authentication server that were captured from the joint user;
e) the second mobile station providing biometric data to the authentication server that were captured from the third user; and
f) the authentication server authenticating the joint user and the third user and providing authentication results required for the execution of the transaction.

4. The method according to claim 1, comprising the steps of
a) capturing biometric audio and video samples of the users during enrolment for dictated speech elements or speech segments and storing the captured audio and video samples together with the personal data of the users in the database;
b) performing on-line authentication of each of the users by
b1) sending at least one challenge or a fraction of a challenge with information containing a sequence of randomly assembled dictated speech elements or speech segments, for which biometric audio and video samples were captured during enrolment, to the mobile stations of the users and requesting a corresponding response;
b2) sequentially capturing biometric audio and video data simultaneously from each of the users via the at least one camera and the at least one microphone of the mobile stations for the response expressed;
b3) the mobile stations forwarding the biometric data captured from the users to the authentication server;
b4) the authentication server
receiving the biometric data of the users online,
retrieving corresponding biometric data of the users captured during enrolment from the database,
assembling the biometric data of the users retrieved from the database to represent the challenge sent to the mobile stations,
comparing the biometric data received online and the biometric data retrieved and assembled and obtaining a match value that is compared with a threshold.

5. The method according to claim 1, comprising the steps of performing authentication of the first and the second user comprises the steps of
a) the mobile station
combining the responses received for the first and the second user in the first mobile station and sending the combined response to the authentication server; and
b) the authentication server
combining the retrieved or the retrieved and assembled biometric data representing the challenge, and
comparing the combined response received from the mobile station with the combined biometric data representing the challenge.

6. The method according to claim 1, comprising the steps of creating templates for the biometric data captured during enrolment and captured during authentication procedures and comparing corresponding characteristics of said templates in order to obtain a match value for each of the users and/or for the combined response of the first and the second user.

7. The method according to claim 5, comprising the steps of creating templates for the biometric data captured during enrolment and captured during authentication procedures and comparing corresponding characteristics of said templates in order to obtain a match value for each of the users and/or for the combined response of the first and the second user.

8. The method according to claim 2, comprising the steps of the authentication server retrieving data from the legal entity related to the users defining authorisation of the users to sign legal contracts and rejecting transactions, if the authorisation to sign is missing.

9. The method according to claim 8, comprising the steps of the mobile stations forwarding a transaction value to the authentication server and the authentication server determining the authorisation of the users to sign with reference to the transaction value.

10. The method according to claim 1, comprising the steps of authenticating the joint users or the single user whether authentication to sign is given for the present transaction.

11. The method according to claim 3, comprising the steps of setting up a conference session with the participation of the users involved in the transaction before initiating the authentication session, and authenticating the users while the conference session is in progress.

12. The method according to claim 1, comprising the steps of the authentication server issuing a certificate reflecting the result of the performed authentication session and indicating at least the users involved and their status of authentication.

13. A biometric system for performing biometric authentication of users that are individually or jointly representing a legal entity with at least one mobile station that comprises
a) at least one display,
b) at least one camera,
c) at least one microphone,
d) an interface that is connectable wirelessly to an authentication server via a mobile communications network, and
e) a programme module supporting execution of the method of claims 1.

14. A mobile station for a biometric system according to claim 13.

15. The mobile station according to claim 14 comprising a camera on the front side and a camera on the rear side and/or comprising a display of the front side and on the rear side.
